(19) United States
(12) Patent Application Publication
(10) Pub. No.: US 2026/0331999 A1
(43) Pub. Date: Oct. 22, 2026

(54) ELECTRIC MACHINE WITH OPTIMIZED COOLING SYSTEM

(71) Applicant: MAGNA Powertrain GmbH & Co KG, Lannach (AT)

(72) Inventors: Michael Dienbauer, Graz (AT); Sebastian Schiller, Graz (AT)

(21) Appl. No.: 19/113,120

(22) PCT Filed: Aug. 21, 2023
(86) PCT No.: PCT/EP2023/072940

§ 371 Date: Mar. 19, 2025

(30) Foreign Application Priority Data
Sep. 20, 2022 (DE) 10 2022 209 904.4

(51) Int. Cl. H02K 9/197; H02K 1/20; H02K 3/24

(52) U.S. Cl. CPC H02K 9/197; H02K 1/20; H02K 3/24

(57) ABSTRACT

An electric machine in a system housing, having a liquid-tight stator and a rotor, includes an oil inlet located on the underside of the system housing. Oil is introduced under pressure into an annular oil distribution volume via the oil inlet, and a connection from the oil distribution volume towards an annular oil tank is implemented axially via a cooling channel in the stator, which cooling channel is introduced near the winding grooves, and a cooling channel inside the winding grooves, and a connection from the oil tank towards an oil outlet is implemented via a cooling channel which is present at the radially outer edge of the stator lamination but inside the stator lamination.

### CROSS-REFERENCE TO RELATED APPLICATIONS

This application is a National Stage of International Application No. PCT/EP2023/072940, filed Aug. 21, 2023, which claims priority to DE 10 2022 209 904.4, filed Sep. 20, 2022. The entire disclosures of each of the above applications are incorporated herein by reference.

### FIELD

The present disclosure relates to an electric machine in a system housing with a stator and a rotor, wherein the electric machine has an oil inlet situated on the underside of the system housing, wherein oil can be introduced under pressure via the oil inlet into an annular oil-distribution volume and be distributed over at least three oil channels in the stator.

### BACKGROUND

This section provides information related to the present disclosure which is not necessarily prior art.

Electric drives are becoming increasingly important.

Currently, stators of electric machines with a hairpin winding are impregnated or potted with plastic before the actual insertion of the wires. This means that the wound stator is additionally treated with a resin or the like in order to fix the winding in the winding grooves and to fix the winding heads on the stator. A corresponding quantity of resin or potting material is necessary in order to coat the whole stator.

The stator also has to be appropriately masked in certain areas such as, for example, the stator internal diameter, in order to avoid excessively adherent material, for example, in the air gap with respect to the rotor.

During operation of the electric machine, heat occurs which has to be discharged by means of a coolant, especially in the case of electric machines with a high power density. For this reason, the machine housing has the coolant inlet port and the coolant outlet port. Coolant can be fed to the machine housing through the coolant inlet port. In contrast, the coolant can be discharged from the machine housing through the coolant outlet port.

DE 10 2017 218 828 A1 discloses an electric machine with a housing. It is provided here that a coolant inlet port opens into a distributor annular space and a plurality of housing cooling channels depart from the distributor annular space which, viewed in the axial direction, extend beyond the stator and are fluidically connected, on their side remote from the distributor annular space, to stator cooling channel inlets of stator cooling channels formed in the stator which reach all the way through the stator in the axial direction and, on their side remote from the stator cooling channel inlets, are connected to the coolant outlet port. The design provides that the stator cooling channels are present between adjacent stator windings or are formed in the stator windings. The stator windings encircle the stator teeth of the stator or are present between the stator teeth at least when viewed circumferentially. The stator cooling channels are delimited by the stator windings in some areas. For this purpose, they are present between adjacent stator windings or are formed in the stator windings. In addition, housing cooling channels are formed as a depression open at the edge or as closed channels in the stator.

DE 10 2011 012 454 A1 discloses an electric machine with an outer stator and an inner stator. A rotor rotates between the two assemblies. The cooling is effected via cooling channels which are routed individually into the different components. The feed line is thus arranged as two parallel channels in the outer stator inside a can and leads into a single branch line.

The inner stator is supplied with coolant via further channels and coolant is removed from it via a further channel.

US 2017 0 267 055 A1 discloses a housing which encloses a stator of an electric machine.

DE 10 2017 210 785 A1 shows cooling channels formed in the stator body and perforations formed in the winding grooves for cooling purposes.

### SUMMARY

This section provides a general summary of the disclosure, and is not a comprehensive disclosure of its full scope or all of its features.

The object of the present disclosure is to develop an electric machine with a cooling system, wherein the cooling system optimally removes heat from the stator.

The object is achieved with an electric machine in a system housing with a liquid-tight stator and a rotor, wherein the electric machine has an oil inlet situated on the underside of the system housing, wherein oil can be introduced under pressure via the oil inlet into an annular oil-distribution volume, and a connection is made via at least one cooling channel in the stator which is provided in the vicinity of the winding grooves, and also via at least one cooling channel inside the winding grooves, axially from the oil-distribution volume in the direction of an annular oil-collection volume, and a connection exists from the annular oil-collection volume, via at least one cooling channel which is present at the edge of the stator lamination but inside it, in the direction of an oil outlet. Oil deflectors, with a shape that matches that of the winding heads, are attached to both sides of the winding heads.

The term cooling channel also includes a group of individual passages and openings with the same function. Thus, the cooling channels are always distributed around the axis of the electric machine.

The direction of flow in two of the cooling channels is thus counter to that in a further cooling channel.

A cooling channel runs inside the winding grooves adjacent to a separation sleeve, wherein the separation sleeve seals the stator from the rotor space of the electric machine completely or only in the stator groove openings.

A cooling channel is arranged in the stator lamination between the radially running winding grooves, wherein a partial radial overlap is present between the cooling channel and the winding grooves.

A cooling channel runs at the edge of the stator laminations.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 shows a section through an electric machine,

FIG. 2 shows a section through a stator,

FIG. 3 is an enlargement of the portion A,

FIG. 4 shows a detail of the winding groove from FIG. 3,

FIG. 5 shows an illustration of the stator with a view of the oil deflector,

FIG. 6 shows the stator with a separated oil deflector,

FIGS. 7 and 8 show the oil deflector,

FIGS. 9 and 10 show the separated oil deflector.

### DETAILED DESCRIPTION

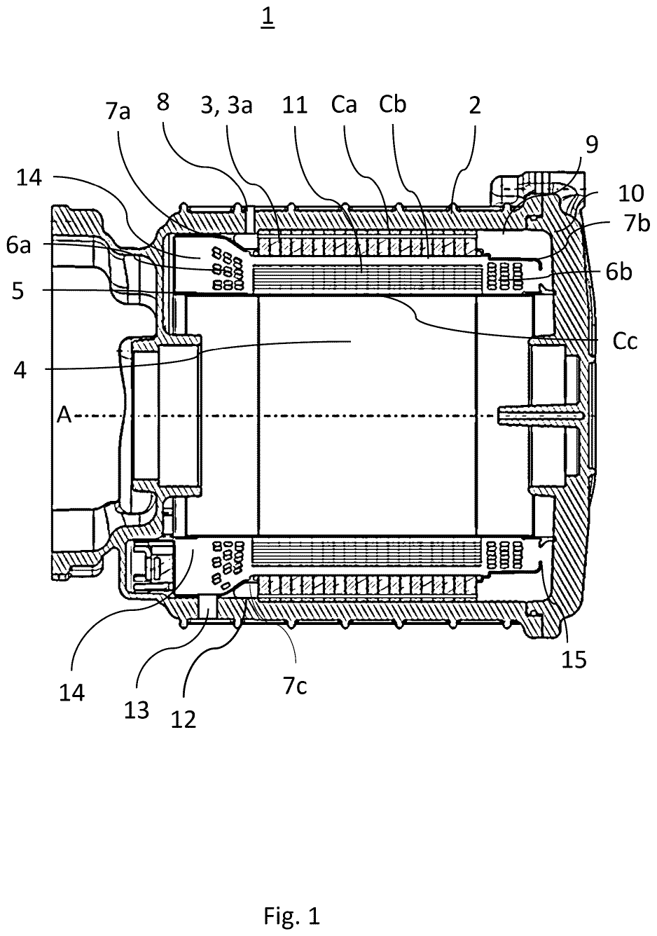

FIG. 1 shows a section through an electric machine 1, wherein the rotor of the electric machine is not illustrated. The rotor is situated in the rotor space 4. A stator 3 is arranged in a system housing 2 which is closed by a housing cover 10. The stator 3 has winding heads 6 which extend on both sides axially adjacent to the longitudinally extending winding grooves 11. The stator 3 is separated from the rotor space 4 by a separation sleeve 5. Three axial cooling channels can be seen in and on the stator 3. The channel Ca runs in a serpentine fashion or in a straight line in the lamination stack 3a of the stator 3, the cooling channel Cb runs in the vicinity of the winding grooves 11, and the channel Cc runs in direct contact with the separation sleeve 5 and the winding grooves 11. An oil inlet 13 which opens into an annular space which comprises an oil-distribution volume 14 is present in FIG. 1. An oil sump 12 is furthermore present at the lowest point of the system housing 2. An oil outlet 8 is attached adjacent to an oil deflector 7a on the upper side of the system housing 2. A further annular oil-collection volume 9 which is closed by the housing cover 10 is provided on the side of the stator 3 which is axially remote from the oil outlet 8. A leakage channel can here also be installed in the housing cover 10 in order to lubricate bearings and teeth.

A further oil deflector 7b is also present which is adapted to the shape of the winding head 7b and runs largely parallel to the axis A. The oil deflector is curved toward the axis A in the direction of the housing cover 10, and the join to the stator is made via a stepped or curved part. In the direction of the housing cover 10, the oil deflector 7b forms at least one opening 15 which is used for deliberate leakage in order to lubricate further components.

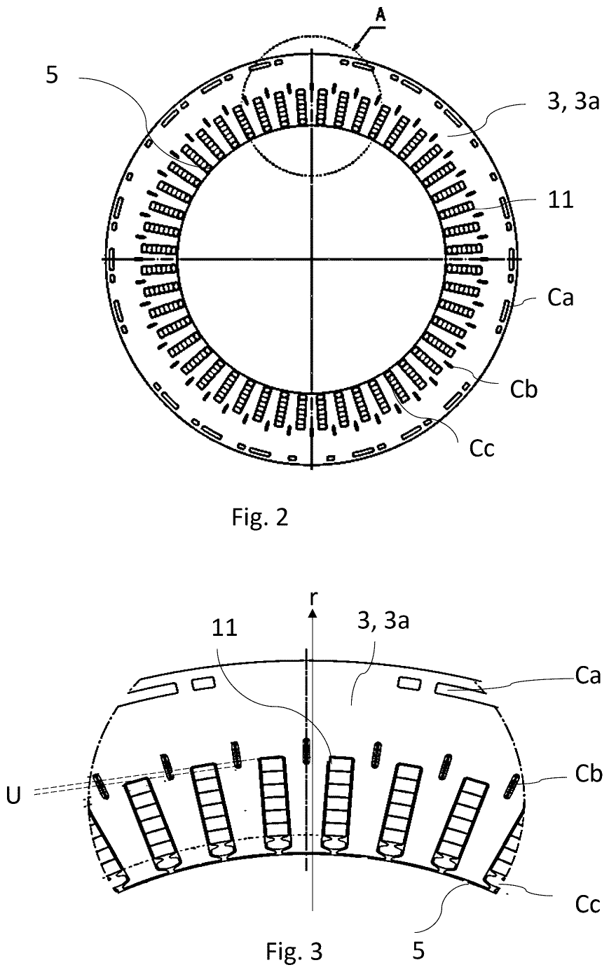

FIGS. 2 and 3 illustrate a view of a section through the stator lamination stack 3a. The separation sleeve 5 which seals the stator in the direction of the rotor space 4 can be seen.

Visible at the outer diameter of the stator 3 are the openings for the cooling channel Ca. The cooling channel Ca here comprises a plurality of openings of the same or different size but which are all arranged on a circumference in the vicinity of the edge of the lamination stack 3a. The cooling channel Cb is constituted by slot-like openings which are located adjacent to the winding grooves 11 but not in direct contact with them. The slot-like openings here overlap radially partially with the radially extending winding grooves 11.

Hairpin windings are installed in the winding grooves 11. The winding grooves additionally offer space for the third channel Cc which is attached directly to the separation sleeve 5 in the winding grooves 11.

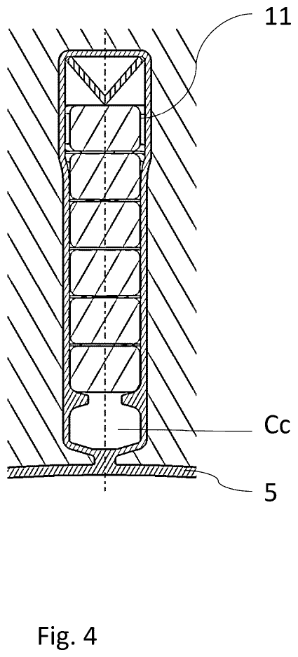

FIG. 4 shows a portion of a winding groove 11 in which the cooling channel Cc is separated from the structural space for the hairpin windings by a projection-like structure.

Cool oil is fed under pressure via an oil inlet 13 situated underneath into the winding head space at the winding heads 6a, namely into the oil-distribution volume, and is distributed circularly around the whole winding head 6a. By virtue of an oil deflector 7a which is adapted to the shape of the winding head 6a, the oil flows to the winding grooves 11 and into the hairpin windings. The oil passes through the channels Cb and Cc, through the stator 3 to the second winding head 6b. This corresponds to an oil flow from left to right in FIG. 1. The second winding head 6b is likewise enclosed with an oil deflector 7b with an adapted shape in order to force the oil flow into the stator lamination stack 3a, to be precise into the channel Ca.

The axial cross section of the oil-distribution volume 14 tapers in the region of the winding head 6a toward the stator. A turbulent flow onto the winding heads is obtained as a result. The oil is consequently pressed through the cooling channels of the winding grooves 11, as a result of which the heat transfer drastically increases. The advantage of the large cross section of the oil-distribution volume is that the winding head is cooled uniformly circumferentially.

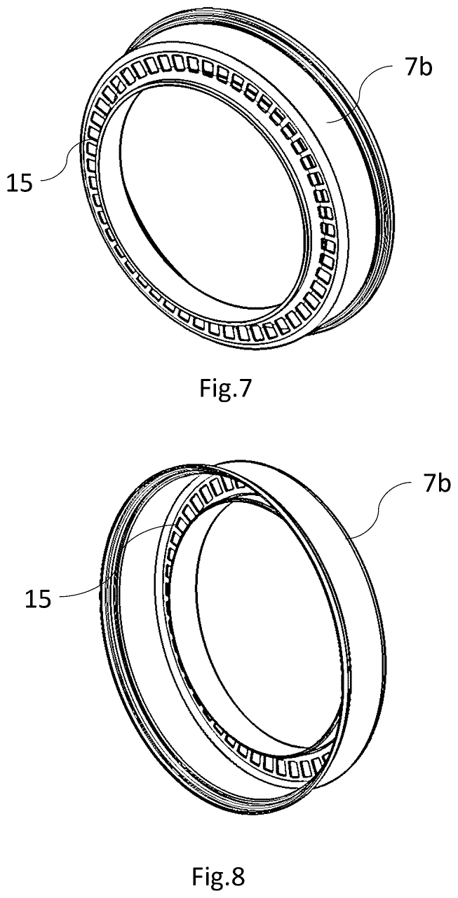

Via openings 15, as also illustrated in FIGS. 5 and 7 and 8, at the end of the oil deflector 7b, the oil passes via the winding head space, the oil-collection volume 9, to the channels Ca which run axially in a straight line or in a serpentine fashion in the stator lamination stack 3a. The oil thus passes in turn back to the winding head space of the winding head 6a, the oil-distribution volume 14. The direction of the oil flow is here from right to left in FIG. 1 and thus counter to the flow of the oil in the channels Ca and Cb.

The oil outlet 8 is shaped as an overflow. It is thus ensured that the whole stator 3 stands in the oil. In addition, the winding head space at the winding heads 6a and 6b serves as an oil-collection volume 9 or as an oil-distribution volume 14 and forms a single oil tank. This allows a saving in structural space for a separate oil tank. Because, owing to the high fill level of the oil up to the outflow 8, an air bubble can be formed at the highest position, a bleed opening is used in the oil separators 7a, 7b at least at a gravimetrically high position.

The rotor is hermetically separated from the stator by the separator sleeve 5, wherein the separator sleeve 5 forms the channel Ca with the winding groove 11. The rotor can thus be designed as a dry rotor, which results in drag losses.

The bidirectional flow of oil through the stator 3 has significant advantages. It allows a higher flow speed and improved heat transfer by virtue of the arrangement in series of the channels Ca with Cb and Cc. A more consistent temperature level of the right-hand and left-hand stator side is achieved.

It is also specified by the flow pattern that the inlet and the outlet 13, 8 are situated axially on the same side of the electric machine.

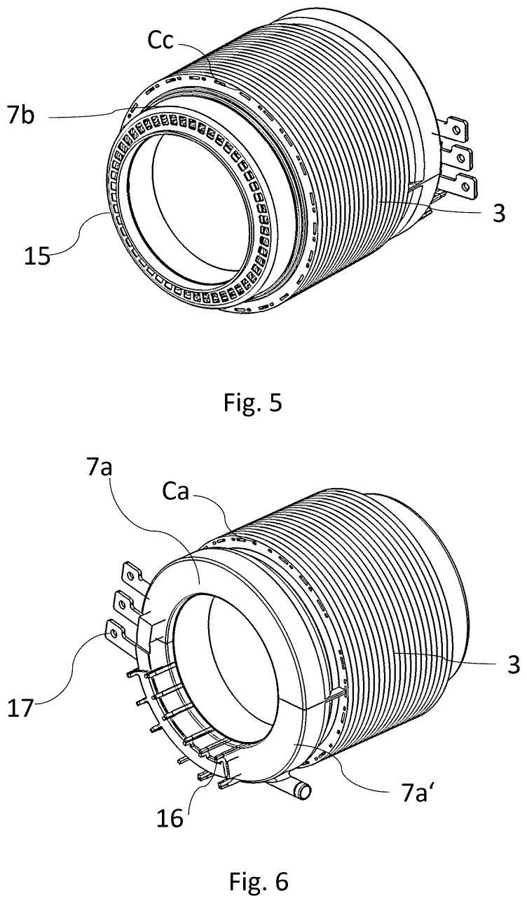

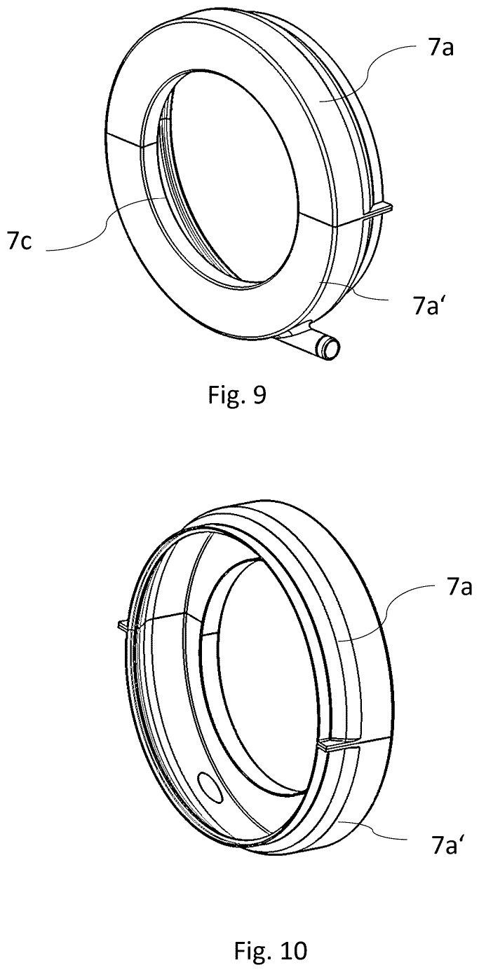

FIGS. 6 and 9 and 10 show schematically a separated oil deflector 7a, 7a′. Undercuts 7c occur by virtue of the adaptation of the oil deflector to the shape of the winding head 6a. A one-part oil separator cannot be installed as a result. Assembly is possible in a simple fashion by virtue of the two-part solution. The separated oil deflectors 7a,7a′ also allows the cooling of the electrical terminals 16 and the busbars 17 which serve as terminals of the electric machine and the stator 3.

### REFERENCE SIGNS

1 electric machine
2 system housing
3 stator
3a stator lamination stack
4 rotor space
5 separation sleeve
6a, 6b winding head
7a, 7a′, 7b oil deflector
7c undercut
8 oil outlet
9 oil-collection volume
10 housing cover
11 winding groove
12 oil sump
13 oil inlet
14 oil-distribution space
15 opening
A axis
Ca, Cb, Cc cooling channels
16 phase terminals
17 busbar

1. An electric machine in a system housing comprising:
a stator having winding heads that extend, on both axial sides of the stator, axially adjacent to the longitudinally extending winding grooves of the stator, and
an annular oil distribution volume,
an oil inlet, wherein oil is introduced under pressure via the oil inlet into the annular oil-distribution volume, and
at least one first cooling channel disposed in the vicinity of the winding grooves,
at least one second cooling channel disposed inside the winding grooves,
at least one third cooling channel disposed at an edge of a stator lamination and inside the stator laminations
wherein a connection is provided, via the first cooling channel and the at least one second cooling channel, axially from the annular oil-distribution volume toward an annular oil-collection volume, and
wherein a connection is provided from the oil-collection volume, via the at least one third cooling channel, toward an oil outlet, and
wherein oil deflectors with a shape that matches that of the winding heads, are attached on both sides of the winding heads of the stator.

2. The electric machine (1) as claimed in claim 1, wherein the oil-distribution volume and the oil-collection volume serve as a single integrated oil tank.

3. The electric machine as claimed in claim 1, wherein a level of the oil in the oil-collection volume lies at the same height as the oil outlet.

4. The electric machine claimed in claim 1, wherein a cross section of the annular oil-collection volume and the annular oil-distribution volume is larger than the first, second, and third cooling channels.

5. The electric machine as claimed in claim 1, wherein a direction of flow in the first and second cooling channels is counter to that of the third cooling channel.

6. The electric machine as claimed in claim 1, wherein the oil inlet and the oil outlet are situated axially on the same axial side of the electric machine.

7. The electric machine as claimed in claim 1, wherein of the second cooling channel runs inside the winding grooves adjacent to a separation sleeve, wherein the separation sleeve seals the stator from a rotor space of the electric machine at least in the region of the winding grooves.

8. The electric machine as claimed in claim 1, wherein the first cooling channel is arranged in the stator lamination between the winding grooves running radially away from a rotational axis of the rotor, wherein a partial radial overlap is present between the first cooling channel and the winding grooves.

9. The electric machine as claimed in claim 1, wherein the third cooling channel runs at the edge of the stator lamination.

10. The electric machine as claimed in claim 1, wherein a two-part oil deflector provided, which comprises windings with an undercut or a conical outer contour of the winding head.

11. The electric machine as claimed in claim 10, wherein the two-part oil deflector comprises phase terminals of the winding head for cooling purposes.

12. The electric machine as claimed in claim 1, wherein at least one of the oil deflectors has a bleed opening at a highest point.

13. The electric machine as claimed in claim 1, wherein the at least one first channel, the at least one second cooling channel, and the at least one third cooling channel each comprise multiple channels distributed around the central axis of the electric machine.

14. The electric machine as claimed in claim 12, wherein the entire stator stands in the oil disposed in the electric machine.

15. The electric machine as claimed in claim 7, wherein the rotor is a dry rotor.

16. The electric machine as claimed in claim 1, wherein an axial cross section of the annular oil-distribution volume tapers in the region of the winding head toward the stator.

17. The electric machine as claimed in claim 1, wherein the first fooling channel is disposed radially between the second cooling channel and the third cooling channel, wherein the third cooling channel is disposed radially outward relative to the first and the second cooling channels.

18. The electric machine as claimed in claim 1, wherein oil flowing through the first and second cooling channels combines in the annular oil collection volume and is routed in the opposite axial direction into the third cooling channels.

19. The electric machine as claimed in claim 1, wherein the first cooling channels are in the form of slot-like openings located adjacent to the winding grooves, wherein the first cooling channels are not in direct contact with the winding grooves.

20. The electric machine as claimed in claim 1, wherein the second cooling channels disposed inside the winding grooves are disposed at a radially inner of the winding grooves.
